(19) United States
(12) Patent Application Publication
(10) Pub. No.: US 2018/0032667 A1
(43) Pub. Date: Feb. 1, 2018

(54) POLICY-MANAGED GENETIC MATERIAL SYNTHESIS SYSTEMS AND METHODS

(71) Applicant: Intertrust Technologies Corporation, Sunnyvale, CA (US)

(72) Inventor: Jarl NILSSON, Mountain View, CA (US)

(73) Assignee: Intertrust Technologies Corporation, Sunnyvale, CA (US)

(21) Appl. No.: 15/662,613

(22) Filed: Jul. 28, 2017

Related U.S. Application Data
(60) Provisional application No. 62/368,340, filed on Jul. 29, 2016.

(51) Int. Cl. G06F 19/18; G06F 19/26; G06N 3/12; G06F 19/20

(52) U.S. Cl. CPC G06F 19/18; G06F 19/20; G06F 19/26; G06N 3/12; G06F 19/10

(57) ABSTRACT

The present disclosure relates generally to systems and methods for enforcing various rights and interests in connection with genetic material synthesis processes. In certain embodiments, the systems and methods disclosed herein may compare a genetic material a user would like to synthesize with a genetic material synthesis system with one or more managed genetic materials. If the genetic material is found to be similar to a managed genetic material (e.g., similar in genetic sequence, synthesizing process, molecular shape and/or structure, etc.), policy associated with the managed genetic material may be enforced in connection with synthesizing the genetic material.

### RELATED APPLICATIONS

This application claims the benefit of priority under 35 U.S.C. § 119(e) to U.S. Provisional Application No. 62/368,340, filed Jul. 29, 2016, and entitled “POLICY-MANAGED GENETIC MATERIAL SYNTHESIS SYSTEMS AND METHODS,” which is hereby incorporated by reference in its entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### SUMMARY

The present disclosure relates generally to systems and methods for managing the synthesis of genetic material. More specifically, but not exclusively, the present disclosure relates to systems and methods for managing the synthesis of genetic material in accordance with enforced rules and/or policies.

Artificial gene synthesis techniques may be used to create a variety of kinds of artificial genetic material. For example, artificial gene synthesis may be used to generate a synthetic double-stranded DNA molecule with any desirable nucleotide sequence and/or nucleotide size. Similarly, gene synthesis techniques may be used to generate artificial plasmids manufactured and used as vectors in molecular cloning that drive the replication of recombinant DNA sequences and/or in other suitable applications.

Consistent with embodiments disclosed herein, the generation of artificial genetic material using gene synthesis techniques may be managed and/or otherwise controlled in accordance with one or more articulated rules and/or policies. As an example, due to the inherent danger of certain genetic material, such as material associated with virulent bacteria and/or viruses, prions, and/or the like, it may be desirable to restrict and/or otherwise limit the production of such material to certain authorized parties (e.g., authenticated researchers demonstrating knowledge and/or implementation of proper biohazard control techniques). Similarly, certain genetic material may be protected and/or otherwise proprietary, as may be the case with genetically-engineered and/or modified organisms or material.

Systems and methods disclosed herein facilitate protection, governance, management, and/or enforcement of rights in connection with the synthesis and/or generation of genetic material. In certain embodiments, the disclosed systems and methods may utilize descriptions of managed genetic material such as sequencing information, material synthesis process step information, molecular shapes, and/or the like, to identify attempts to generated managed genetic material and/or genetic material similar to managed genetic material using a genetic material synthesis system.

Embodiments disclosed herein may be used to analyze genetic material prior to its generation, identify whether the analyzed material is associated with one or more rules and/or policies, and/or enforce any identified rules and/or policies in connection with generation of the material. For example, in some embodiments, prior to synthesizing genetic material, a control system associated with a genetic material synthesis system may determine whether the genetic material is the same and/or similar to known managed genetic material. To determine whether the genetic material is the same and/or similar to a known managed genetic material, the control system and/or a related system may compare information associated with the genetic material with information associated with various known genetic materials. In certain embodiments, such a comparison may include comparing and/or otherwise analyzing a genetic material's associated genetic sequence, synthesis process steps, molecular shape and/or structure, and/or the like relative to a known managed genetic material.

If it is determined that a genetic material is not the same or sufficiently similar to a known managed genetic material, the control system may allow the genetic material synthesis system to proceed with synthesizing the genetic material. If it is determined that a genetic material is the same or sufficiently similar to a known managed genetic material, the control system may identify and enforce one or more articulated policies associated with the managed genetic material. In certain embodiments, such a policy may prevent generation and/or synthesis of the genetic material by the genetic material synthesis system. In further embodiments, a policy may articulate that certain conditions be met prior to allowing synthesis of a genetic material to proceed (e.g., purchasing rights associated with a managed genetic material, registration with a rights holder and/or other authority, demonstrating authorization to synthesize a managed genetic material, and/or the like). In yet further embodiments, a policy may articulate that certain actions be performed in connection with synthesizing a genetic material (e.g., notifying a rights holder, law enforcement, and/or governmental authorities, etc.). It will be appreciated that a variety of other types of policies may be articulated, and that any type of policy may be utilized in connection with the disclosed embodiments.

By ensuring that genetic material that is the same and/or similar to known managed genetic material is identified in connection with genetic material generation and/or synthesis activities, unauthorized production of the managed genetic material using genetic material synthesis technologies may be mitigated. Moreover, by preventing the unauthorized synthesis of certain dangerous, illegal, and/or otherwise controlled genetic material and enabling notifications to be sent to authorities of attempts to synthesize such genetic material, the production and/or distribution of controlled genetic material may be reduced.

### BRIEF DESCRIPTION OF THE DRAWINGS

The inventive body of work will be readily understood by referring to the following detailed description in conjunction with the accompanying drawings, in which:

FIG. 1 illustrates a system for enforcing policy in connection with a genetic material synthesis system consistent with embodiments of the present disclosure.

FIG. 2 illustrates a conceptual diagram of information flow between various functional modules associated with a genetic material synthesis system consistent with embodiments of the present disclosure.

FIG. 3 illustrates a flow chart of a method for managing synthesis of genetic material consistent with embodiments of the present disclosure.

FIG. 4 illustrates a flow chart of an exemplary method 400 for comparing a genetic material with known managed genetic materials consistent with embodiments of the present disclosure.

FIG. 5 illustrates a system that may be used to implement certain embodiments of the systems and methods of the present disclosure.

### DETAILED DESCRIPTION

A detailed description of the systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to the drawings, wherein like parts may be designated by like numerals. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of any method disclosed herein do not necessarily need to be executed in any specific order, or even sequentially, nor need the steps be executed only once, unless otherwise specified.

Systems and methods disclosed herein facilitate protection, governance, management, and/or enforcement of rules and/or policies in connection with the generation of artificial and/or otherwise synthesized genetic material. As used herein, the term “genetic material” may generally refer to any material, including artificial and/or otherwise synthesized material, that comprises information encoded in one or more genes. Information may be encoded in DNA or RNA, and may be represented as mRNA or as protein sequences derived from these nucleic acid sequences. Genetic material may include, for example, artificial plasmids—small, circular, double-stranded DNA molecules distinct from chromosomal DNA that can replicate independently—used to encode various types of information. Genetic material may further include living organisms including synthesized genetic information. It will be appreciated that a wide variety of genetic material may be used in connection with the disclosed systems and methods, and that the various embodiments may be used in connection with any suitable type of synthesized genetic material.

In certain embodiments, the disclosed systems and methods may use information such as, for example, descriptions of managed genetic material to identify attempts to synthesize managed genetic material and/or genetic material similar to managed genetic material using a genetic material synthesis system. Such descriptions may comprise, without limitation, one or more of descriptions of managed genetic material such as sequencing information, material synthesis process step information, molecular shapes and/or structures, and/or the like. Managed genetic material may include any genetic material that may be created by a genetic material synthesis system.

To determine whether the genetic material is the same and/or similar to a known managed genetic material, the control system and/or a related system may compare information associated with the genetic material with information describing various known managed genetic materials. In certain embodiments, this may include comparing and/or otherwise analyzing one or more genetic sequences associated with material and/or information or fingerprints associated with the same relative to that of a known managed genetic material. A variety of techniques may be utilized to compare a genetic material with known genetic material in connection with the disclosed embodiments including, without limitation, using fingerprint and/or hashing techniques and/or the like.

In some embodiments, the systems and methods described herein can, for example, be used in connection with digital rights management (“DRM”) technologies such as those described in commonly assigned, co-pending U.S. patent application Ser. No. 11/583,693 (“the '693 application”) and/or the service orchestration technologies such as those described in commonly assigned co-pending U.S. patent application Ser. No. 10/863,551 (“the '551 application), as well as in other contexts. It will be appreciated that these systems and methods are novel, as are many of the components, systems, and methods employed therein.

Genetic Material Synthesis Policy Enforcement Architecture

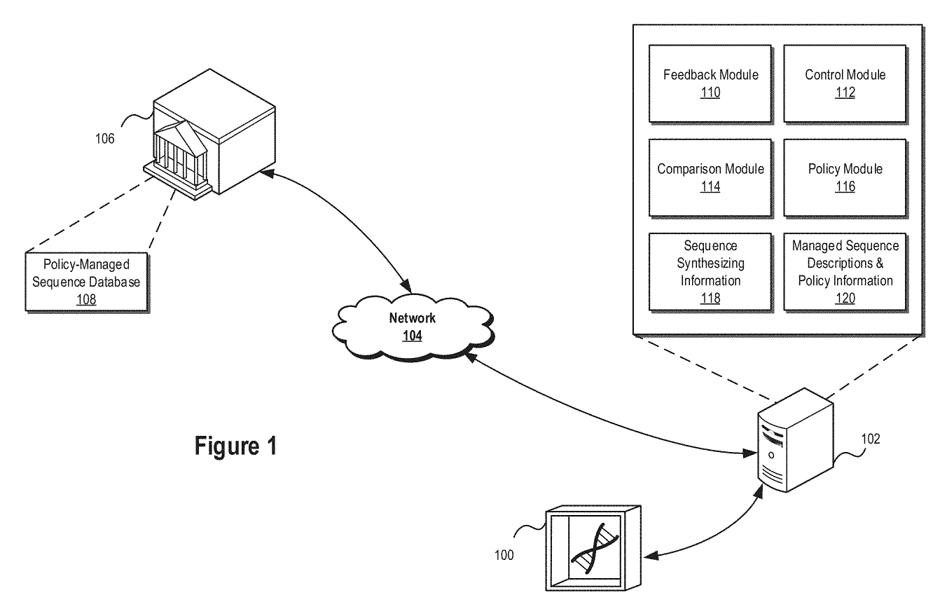

FIG. 1 illustrates a system for enforcing policy in connection with the operation of a genetic material synthesis system 100 consistent with embodiments of the present disclosure. The genetic material synthesis system 100 may comprise any type of genetic material synthesis system suitable for synthesizing genetic material and/or gene sequences. The genetic material synthesis system 100 may employ a variety of artificial genetic synthesis technologies including, for example, one or more of DNA replication, polymerase chain reaction, oligonucleotide synthesis, annealing based connection of oligonucleotides, and/or any combination of the same.

Operation of the genetic material synthesis system 100 may be controlled by a control system 102. The control system 102 may be communicatively coupled to one or more other systems via a network 104. For example, the control system may communicate with a trusted authority 106 maintaining a managed genetic material sequence database 108 and associated policies used in connection with the disclosed embodiments. Although illustrated as separate systems, it will be appreciated that in other embodiments, certain functions of the genetic material synthesis system 100, the control system 102, and/or the trusted authority 106 may be performed by a single system and/or any suitable combination of systems.

The control system 102, trusted authority 106, and/or one or more other associated systems (not shown) may comprise any suitable computing system or combination of systems configured to implement embodiments of the systems and methods disclosed herein. In certain embodiments, the control system 102, trusted authority 106, and/or other associated systems may comprise at least one processor system configured to execute instructions stored on an associated non-transitory computer-readable storage medium. As discussed in more detail below, the control system 102, trusted authority 106, and/or other associated systems may further comprise a secure processing unit (“SPU”) configured to perform sensitive operations such as trusted credential and/or key management, secure policy management and enforcement, and/or other aspects of the systems and methods disclosed herein. The control system 102, trusted authority 106, and/or other associated systems may further comprise software and/or hardware configured to enable electronic communication of information between the systems via one or more associated network connections of the network 104 and/or other connections.

The control system 102 may comprise a computing device executing one or more applications and/or software modules 110-116 configured to implement embodiments of the systems and methods disclosed herein. In certain embodiments, the control system 102 may comprise a laptop computer system, a desktop computer system, a smartphone, a tablet computer, and/or any other computing system and/or device that may be utilized in connection with the disclosed systems and methods. In some embodiments, the control system 102 may be communicatively coupled to the genetic material synthesis system 100 and be configured to control the operation thereof. In further embodiments, the control system 102 and the genetic material synthesis system 100 may be integrated into a single system. In certain embodiments, the control system 102 may comprise software and/or hardware configured to, among other things, control genetic information synthesis operations performed by the genetic material synthesis system 100, identify attempts to synthesize managed genetic material, and/or enforce associated policies in connection with the same.

The control system 102 may communicate with the trusted authority 106 and/or other systems via a network 104 comprising any suitable number of networks and/or network connections. The network connections may comprise a variety of network communication devices and/or channels and may utilize any suitable communication protocols and/or standards facilitating communication between the connected devices and systems. The network connections may comprise the Internet, a local area network, a virtual private network, and/or any other communication network utilizing one or more electronic communication technologies and/or standards (e.g., Ethernet or the like). In some embodiments, the network connections may comprise a wireless carrier system such as a personal communications system (“PCS”), and/or any other suitable communication system incorporating any suitable communication standards and/or protocols. In further embodiments, the network connections may comprise an analog mobile communications network and/or a digital mobile communications network utilizing, for example, code division multiple access (“CDMA”), Global System for Mobile Communications or Groupe Special Mobile (“GSM”), frequency division multiple access (“FDMA”), and/or time divisional multiple access (“TDMA”) standards. In certain embodiments, the network connections may incorporate one or more satellite communication links. In yet further embodiments, the network connections may utilize IEEE's 802.11 standards, Bluetooth®, ultra-wide band (“UWB”), Zigbee®, and or any other suitable communication protocol(s).

Genetic Information Synthesis Control

Operation of the genetic material synthesis system 100 may be controlled, at least in part, by a control module 112 executing on the control system 102. Among other things, the control module 112 may issue one or more instructions to the genetic material synthesis system 100 in connection with synthesizing genetic information. The instructions for synthesizing genetic material may be based on sequence synthesizing information 118 stored by the control system 102. In certain embodiments, the sequence synthesizing information 118 may comprise a description of the genetic material and/or sequence to be synthesized. For example, the sequence synthesizing information 118 may comprise a description of a gene sequence to be synthesized. In some embodiments, the information included in the sequence synthesizing information 118 may comprise a description of the genetic sequence at varying degrees of resolution and/or granularity.

In some embodiments, the sequence synthesizing information 118 may comprise one or more process steps and/or control instructions to be implemented by the genetic material synthesis system 100 in connection with synthesizing genetic material. In yet further embodiments, the control module 112 may analyze the description of the genetic material to be synthesized included in the sequence synthesizing information 118 and generate instructions for synthesizing the genetic material based on the capabilities of the genetic material synthesis system 100. That is, the control module 112 may determine how to synthesize the genetic material with the genetic material synthesis system 100 based on a description of the material included in the sequence synthesizing information 118, such as sequence information (e.g., without or with aid from pre-existing instructions included in the sequence synthesizing information 118).

Sequence synthesizing information 118 may be provided to the control system 102 in a variety of ways. For example, in some embodiments, a user of the control system 102 and/or the genetic material synthesis system 100 may provide the sequence synthesizing information 118 to the control system 102 via a suitable user interface and/or a computer-readable storage medium or the like (e.g., a USB drive or other physical media). In other embodiments, the sequence synthesizing information 118 can be downloaded from another system. For example, a third-party service provider may offer a variety of types of genetic material synthesis information 118 for download and/or purchase. A user of the control system 102 and/or the genetic material synthesis system 100 may select a desired material from the service and receive associated sequence synthesizing information 118 for use by the control system 102 and/or the genetic material synthesis system 100. In yet further embodiments, sequence synthesizing information 118 may be created by a user of the control system 102 and/or the genetic material synthesis system 100 using, at least in part, a software application for designing genetic sequences.

A feedback module 110 executing on the control system 102 may receive information from the genetic material synthesizing system 100 and/or generate information based on feedback signals received from the genetic material synthesizing system 100 regarding a status of the system 100 and/or a genetic material being synthesized by the system 100. In further embodiments, the feedback module 110 may receive and/or generate information regarding various environmental parameters relating to the genetic material synthesis system 100 and/or genetic material being synthesized by the system 100. In certain embodiments, such information may be utilized by the control system 102 (e.g., and/or an associated control module 112) and/or the genetic material synthesis system 100 in connection with adjusting parameters and/or other control instructions used in synthesizing genetic material.

Registration of Managed Genetic Material

In certain embodiments, a rights holder owning rights to a managed genetic material, a governmental authority (e.g., law enforcement and/or governmental health organizations) or other authority implementing controls, policies, and/or checks relating to managed genetic material, and/or any other party, may provide policy information and/or managed sequence descriptions to the trusted authority 106 for inclusion in a policy-managed sequence database 108. In certain embodiments, the policy information and/or managed sequence descriptions may be provided to the trusted authority 106 as part of a registration process of an associated managed genetic material. The policy information and/or managed sequence descriptions may comprise a sequence description of an associated managed genetic material (e.g., a description at varying degrees of resolution and/or granularity). The policy information and/or managed sequence descriptions may further comprise instructions to be implemented by a genetic material synthesis system 100 in connection with synthesizing an associated managed genetic material. In yet further embodiments, the policy information and/or managed sequence descriptions may comprise one or more descriptions of a molecular shape and/or structure of a managed genetic material

In some embodiments, the policy information and/or managed sequence description may comprise policy information associated with the managed genetic material. The policy information may articulate certain restrictions, conditions, requirements, and/or other actions associated with synthesizing the managed genetic material. Policy information may articulate, without limitation, policies preventing and/or otherwise restricting the synthesis of managed genetic material, policies articulating that certain conditions be met prior to synthesis of managed genetic material (e.g., purchasing rights associated with the managed genetic material, registration with a rights holder, demonstrating authorization to synthesize the managed genetic material, etc.), policies articulating that certain actions be performed in connection with synthesis of managed genetic material (e.g., notifying a rights holder, law enforcement, and/or governmental authorities, etc.), and/or the like. It will be appreciated that a variety of other types of policies may be associated with managed genetic material, and that any type of policy articulating any restrictions, conditions, requirements, and/or actions to be enforced in connection with synthesis of managed genetic material may be utilized in connection with the disclosed embodiments.

Policy information and/or managed sequence descriptions provided to the trusted authority may be stored, managed, and/or maintained by the trusted authority 106 in a managed sequence database 108. The managed sequence database 108 may store policy information and/or managed sequence descriptions associated with a plurality of managed genetic materials. In certain embodiments, the policy information and/or managed sequence descriptions included in the managed sequence database 108 may include information provided by a one or more of rights holders, governmental authorities, and/or other authorities implementing managed genetic material controls and/or checks. In this manner, the trusted authority 106 and/or managed sequence database 108 may operate as a centralized repository storing information relating to a variety of managed genetic materials from a variety of authorities. As discussed in more detail below, certain contents of the managed sequence database 108 may be distributed to control systems 102 associated with genetic material synthesis systems 100 for use in connection with the disclosed systems and methods. For example, contents of the manage sequence database 108 may be communicated to the control system 102 in response to requests received from the control system 102, in connection with a registration process for the control system 102 and/or the genetic material synthesis system 100, and/or the like.

Genetic Material Sequence Comparison

Before synthesizing genetic material described by the sequence synthesizing information 118 with the genetic material synthesis system 100, the control system 102 may determine whether the genetic material is the same and/or similar to a known managed genetic material. To determine whether the genetic material is the same and/or similar to a known managed genetic material, the control system and/or a comparison module 114 executing thereon may compare the sequence synthesizing information 118 with managed sequence descriptions 120 describing various known managed genetic materials.

As discussed above, the managed sequence descriptions 120 may be provided to the control system 102 from the trusted authority 106 (e.g., from information included in the managed sequence database 108 maintained by the trusted authority 106). Managed sequence descriptions 12—may be provided to the control system 102 in response to a request to synthesize a genetic material, as part of a periodic update, as part of a registration process, and/or by any other suitable mechanism.

Although embodiments described herein may utilize a comparison module 114 executing on the control system 102 to compare sequence synthesizing information 118 with managed sequence descriptions 120, in other embodiments such a comparison may be performed by the trusted authority 106 and/or one or more other systems which may comprise remote systems. For example, in some embodiments, the sequence synthesizing information 118 may be communicated to the trusted authority 106 and/or another system from the control system 102 in response to a request to synthesize genetic material. In such embodiments, the trusted authority 106 and/or other system may compare the received sequence synthesizing information 118 with managed sequence descriptions included in a database 108 maintained by the trusted authority 106.

A variety of features of a genetic material reflected in the sequence synthesizing information 118 may be compared with features of known managed genetic materials reflected in the managed sequence descriptions 120 to determine whether the genetic material is the same and/or similar to a known managed genetic material. For example, in some embodiments, a genetic sequence and/or a portion thereof of a genetic material represented by the sequence synthesizing information 118 may be compared with a genetic sequence and/or portion thereof reflected in a managed sequence description.

In some embodiments, derived information and/or fingerprints associated with a genetic sequence and/or a portion thereof of a genetic material represented by the sequence synthesizing information 118 may be compared with derived information and/or fingerprints associated with a genetic sequence and/or portion thereof reflected in a managed sequence description 120. For example, in some embodiments, a hash of a genetic sequence and/or a portion thereof of a genetic material represented by the sequence synthesizing information 118 may be computed. The computed hash may be compared with a hash associated with a genetic sequence and/or portion thereof reflected in a managed sequence description 120. If the hash values match, it may be determined that the genetic material represented by the sequence synthesizing information 118 is the same and/or similar to a managed genetic material.

In further embodiments, one or more genetic sequences associated with a genetic material to be rendered and/or portions thereof may be compared relative to known managed genetic materials at varying degrees of resolution and/or granularity. For example, in some embodiments, a first portion of a genetic sequence associated with a genetic material represented by the sequence synthesizing information 118 having a first sequence length may be compared with information reflected in managed sequence descriptions 120. If the first portion of the genetic sequence matches and/or is similar to information reflected in the managed sequence descriptions 120, a second portion of the genetic sequence having a second sequence length that is longer than the first sequence length may be compared with information reflected in managed sequence descriptions 120.

If the second portion of the genetic sequence matches and/or is similar to information reflected in the managed sequence descriptions 120, it may be determined with a higher degree of confidence that the genetic material represented by the sequence synthesizing information 118 is a managed genetic material. If, however, the second portion of the genetic sequence does not match and/or is not similar to the information reflected in the managed sequence description 120, it may be determined that the associated genetic material is either not managed genetic material and/or is only similar to a certain degree with a managed genetic material. In this manner, the computational analyses required in comparing a genetic material reflected by the sequence synthesizing information 118 with managed sequence descriptions 120 may, in instances of dissimilar genetic material, be reduced.

In additional embodiments, a variety other comparison techniques and/or combinations thereof may be employed in connection with the disclosed embodiments. For example, the comparison module 114 may first compare hashes of genetic sequences and, based on the results (i.e., if the hashes match), subsequently compare entire sequences and/or portions thereof. In further embodiments, as discussed in more detail below, the comparison module 114 may compare genetic sequences and/or portions thereof and the molecular structure of genetic material to be synthesized with one or more molecular structures delineated in the managed sequence description information 120 in connection with determining whether a genetic material is the same and/or similar to a certain degree with a managed genetic material. Similarly, the comparison module 114 may compare genetic sequences and/or portions thereof and various synthesis process steps to synthesize the genetic material in connection with determining whether a genetic material is the same and/or similar to a certain degree with a managed genetic material. It will be appreciated that a variety of other suitable comparison techniques and/or combination of techniques may be utilized to compare a genetic material with known genetic material in connection with the disclosed embodiments, and that any suitable technique and/or combination of techniques may be employed in connection with the disclosed systems and methods.

Genetic Material Synthesis Process Step Comparison

In certain embodiments, to determine whether the genetic material is the same and/or similar to a known managed genetic material, the control system 102 and/or a comparison module 114 executing thereon may compare one or more process steps articulated in and/or otherwise associated sequence synthesizing information 118 with process steps articulated in managed sequence descriptions 120 associated with various known managed genetic materials. For example, control instructions for synthesizing a genetic material using the genetic material synthesis system 100 reflected in the sequence synthesizing information 118 may be compared with one or more control instructions included in the managed sequence descriptions 120 to determine a degree of similarity. In some embodiments, various synthesis process steps and/or control instructions may be examined in parallel and/or otherwise parsed in connection with comparing the steps and/or instructions with information included in the managed sequence descriptions 120.

In some embodiments, process steps and/or control instructions may be analyzed by the comparison module 114 to determine a resulting genetic sequence of a genetic material if the process steps were performed and/or the control instructions issued to the genetic material synthesis system 100. That is, a resulting genetic sequence may be derived based on the process steps and/or control instructions associated with the sequence synthesizing information 118. The resulting sequence information may be compared with information included in the managed sequence descriptions 120 to determine whether the process steps and/or control instructions are associated with a managed genetic material.

Genetic Material Molecular Shape Comparison

Molecular shape information may further be used to compare a genetic material with one or more managed genetic materials reflected in information included in the managed sequence descriptions 120. In certain instances, comparing molecular shape and/or structure may help to identify potentially dangerous genetic material that, when considered solely based on its genetic sequence, is not necessarily concerning. For example, certain proteins may be genetically similar to material that is not harmful, but due to their structural shape may be extremely pathogenic and dangerous. In the case of prions, a cause of transmissible spongiform encephalopathies, the nature of their folded protein structure allows a prion to transmit a misfolded structure to other proteins, leading to a fatal brain disease that is epidemiologically similar to the spread of a viral infection.

Comparing the molecular shape and/or structure of a genetic material with known managed genetic materials consistent with the disclosed embodiments may thus help identify and control the synthesis of such potentially dangerous genetic material.

In certain embodiments, molecular shape and/or structural information may be derived from sequence information, control instructions, and/or process steps reflected in sequence synthesizing information 118. In further embodiments, the molecular shape and/or structural information may be included in the sequence synthesizing information 118. The molecular shape and/or structural information may be compared with, molecular shape and/or structural information included in and/or derived from information included in the managed sequence descriptions 120 to determine if the molecular shape and/or structure is the same and/or similar to that of a managed genetic material.

In some embodiments, a comparison of molecular shape and/or structure may be performed prior to analyzing specific sequence information, as the shape and/or structure of a genetic material may provide an indication of its bioactivity. In certain embodiments, this may allow certain concerning managed genetic materials to be identified which are dangerous irrespective of their underlying genetic sequence. In further embodiments, shape and/or structure may be performed following a comparison of sequence, control instruction, and/or process step information.

Policy Enforcement

Upon determining that a genetic material to be synthesized is the same or similar to a known managed genetic material (e.g., based on a comparison between sequence synthesizing information 118 and/or information derived therefrom and managed sequence descriptions 120), the comparison module 114 may provide an indication of similarity between the materials to a policy module 116 executing on the control system 102. The policy module 116 may be configured to, among other things, enforce policy associated with the managed genetic material in connection with synthesizing the genetic material using the genetic material synthesis system 100. In certain embodiments, the policy may be articulated in policy information included in the managed sequence description and policy information 120 associated with the known managed genetic material. In further embodiments, the policy may be identified and/or otherwise retrieved from the trusted authority 106 and/or another system maintaining policies associated with known managed genetic materials.

A variety of policies may be associated with a known managed genetic material and enforced by the policy module 116. In some embodiments, a policy may articulate certain restrictions, conditions, requirements, and/or other actions associated with synthesizing genetic material deemed similar to a known managed genetic material with the genetic material synthesis system 100. Policy information may articulate, without limitation, policies preventing and/or otherwise restricting the rendering of the genetic material, policies articulating that certain conditions be met prior to rendering of the genetic material (e.g., purchasing rights associated with the genetic material, registration with a rights holder, demonstrating authorization to synthesize the genetic material, etc.), policies articulating that certain actions be performed in connection with synthesizing the genetic material (e.g., notifying a rights holder, law enforcement, and/or governmental authorities, etc.), and/or the like. It will be appreciated that a variety of other types of policies may be associated with synthesizing a genetic material deemed similar to a managed genetic material, and that any type of policy articulating any restrictions, conditions, requirements, and/or actions to be enforced in connection with synthesizing the similar genetic material may be utilized in connection with the disclosed embodiments.

Examples of policies that may be implemented in connection with the disclosed embodiments may include, without limitation, the following:
A requirement that a rights holder or other entity receive payment prior to allowing synthesis of a genetic material deemed similar to a known managed genetic material.
A requirement that a user provide proof of possessing a valid license and/or authorization before rendering of a genetic material similar to a known managed genetic material that may be hazardous and/or virulent.
A restriction that a genetic material be synthesized with certain modifications (e.g., modifications that render the genetic material bioactively innocuous).

It will be appreciated that the foregoing are examples of possible policies, and that any suitable policies may be associated with known managed genetic materials and enforced by the control system 102. In some embodiments, policies may be expressed and enforced using techniques described in the '693 patent; however, it will also be appreciated that any other suitable policy expression and enforcement framework could also be used in connection with the disclosed embodiments.

If restrictions, conditions, requirements, and/or other actions associated or articulated in an enforced policy are satisfied, the policy module 116 may provide the control module 112 with an indication that the policy has been satisfied. Upon receiving the indication, the control module 112 may proceed with issuing instructions to the genetic material synthesis system 100 to synthesize the genetic material. If the restrictions, conditions, requirements, and/or other actions articulated in the policy are not satisfied, however, the policy module 116 may provide the control module 112 with an indication that the policy has not been satisfied or, alternatively, provide no indication of policy compliance to the control module 112. Upon receipt of the indication or non-receipt of a policy compliance indication, the control module 112 may terminate transmission and/or otherwise not transmit issue control instructions to the genetic material synthesis system 100, thereby preventing synthesis of the genetic material.

In certain embodiments, upon receipt of a policy compliance indication from the policy module 116, the control module 112 may issue control instructions to the genetic material synthesis system 100 that may be, at least in part, different or otherwise modified from that articulated in the sequence synthesizing information 118 based on an associated enforced policy. For example, a policy associated with a managed genetic material may articulate that unless a user of a genetic material synthesis system 100 demonstrates possession of a license and/or an electronic indication (e.g., an electronic certificate or the like) to render the genetic material from a regulatory authority, the control module 112 may only issue instructions to the genetic material synthesis system 100 to synthesize the genetic material if the control instructions cause the associated sequence to be modified in a manner rendering the resulting genetic material innocuous. In this way, enforced policy may modify how the control module 112 applies the sequence synthesizing information 118 in connection with issuing control instructions to the genetic material synthesis system 100. It will be appreciated that the control module 112 may issue control instructions, not issue control instructions, and/or otherwise modify control instructions in connection with policy enforcement and/or compliance processes, and that any type of action by the control module 112 in compliance with applicable policies may be implemented in connection with the embodiments disclosed herein.

Trusted Boundaries and Encrypted Communication

In some embodiments, the genetic material synthesis system 100, the feedback module 110, the control module 112, the comparison module 114, and/or the policy module 116, may be enclosed in a trusted boundary. In certain embodiments, the trusted boundary may comprise a trusted manufacturing boundary. In further embodiments, the trusted authority 106 and/or one or more other systems utilized in connection with the disclosed embodiments may also be included in a trusted boundary. In certain embodiments, including devices, modules, and/or systems in a trusted boundary may ensure integrity of the devices, modules, and/or systems and/or information communicated therebetween, thereby improving the ability of the disclosed embodiments to enforce policy associated with managed genetic material by reducing the potential for tampering and/or circumvention of certain policy enforcement controls. For example, in some embodiments, severing communication and/or modifying the flow of information between one or more modules 110-116 and/or systems 100, 102, 106 may render the genetic material synthesis system 100 inoperable, thereby preventing the unauthorized rendering of known genetic materials.

In some embodiments, information communicated between various devices, modules, and/or systems may be encrypted and/or otherwise cloaked to make it difficult to modify information flow therebetween in a subversive way. In certain embodiments, the various devices, modules, and/or systems may include cryptographic modules and/or sub-modules configured to enable cryptographic or otherwise secure communication therebetween.

It will be appreciated that a number of variations can be made to the architecture and relationships presented in connection with FIG. 1 within the scope of the inventive body of work. For example, without limitation, in some embodiments, some or all of the functions performed by the genetic material synthesis system 100 and/or the control system 102 may be performed by the trusted authority 106. Similarly, some or all of the functions performed by the trusted authority 106 may be performed by the genetic material synthesis system 100 and/or the control system 102. Thus it will be appreciated that the architecture and relationships illustrated FIG. 1 are provided for purposes of illustration and explanation, and not limitation.

System Information Flow Example

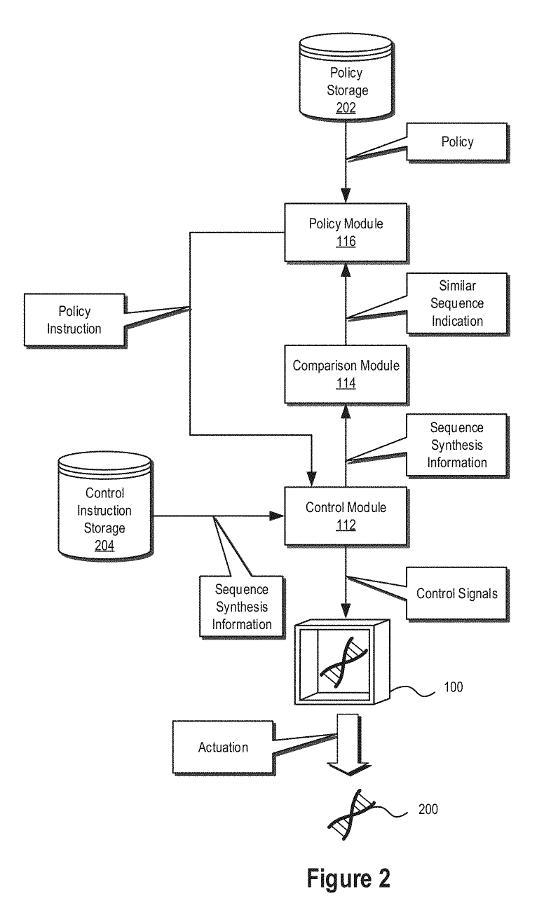

FIG. 2 illustrates a conceptual diagram of information flow between various functional modules associated with a genetic material synthesis system consistent with embodiments of the present disclosure. In certain embodiments, the various function modules may be included in a control system associated with the genetic material synthesis system. A user of a genetic material synthesis system may wish to synthesize a genetic material 200 using the system. As part of a request from the user to render the genetic material, sequence synthesizing information may be passed to the control module 112 from a storage 204 storing sequence information and/or control instructions for synthesizing the genetic material 200. In certain embodiments, the storage 204 may be associated with the requesting user. In further embodiments, the storage 204 may be associated with a system and/or library storing sequence information, control instructions, and/or other information for synthesizing a variety of genetic materials.

Upon receipt of the sequence synthesis information, the control module 112 may pass the synthesis information to a comparison module 114. The comparison module 114 may perform various functions in connection with determining whether the genetic material 200 is the same and/or similar to a known managed genetic material consistent with embodiments disclosed herein. To determine whether the genetic material 200 is the same and/or similar to a known managed genetic material, the comparison module 114 may compare the received sequence synthesis information with information describing various known managed genetic materials. As detailed above, the comparison may involve one or more of comparing genetic sequences and/or portions thereof, comparing information derived from genetic sequences and/or portions thereof, comparing various associated control instructions and/or process steps, comparing molecular shape and/or structure, and/or the like.

The comparison module 114 may provide an indication of a result of the comparison to a policy module 116. For example, the comparison module 114 may provide the policy module 116 with an indication that the genetic material 200 is similar to a managed genetic material. In further embodiments, the indication may comprise a degree and/or manner in which the genetic material 200 is similar to a managed genetic material.

Based on the indication, the policy module 116 may enforce one or more policies associated with a known managed genetic material. In certain embodiments, such policies may be retrieved from either a local or remote policy storage 202 storing a variety of policies associated with a variety of known managed genetic materials. If the received indication indicates the genetic material 200 is not similar to a managed genetic material, the policy module may determine that the genetic material is not policy-managed and provide an associated policy instruction to the control module 112 indicating that synthesis of the genetic material may proceed without policy restriction. In response, the control module 112 may issue control signals to the genetic material synthesis system 100 causing actuation of the system in connection with synthesizing the genetic material.

If the indication received by the policy module 116 indicates the genetic material is similar to a known managed genetic material, the policy module 116 may proceed to retrieve and enforce a policy associated with the managed genetic material in connection with synthesizing the genetic material. The policy module 116 may issue one or more policy instructions to the control module 112 as part of a policy enforcement process. For example, the policy module 116 may provide policy instructions restricting the control module 112 from causing the genetic material synthesis system 100 to synthesize the genetic material 200. Similarly, the policy module 116 may provide policy instructions indicating that requirements and/or conditions of an associated policy have been satisfied and that synthesis of the genetic material 200 may proceed. In yet a further example, the policy module may provide policy instructions indicating that policy requires certain restrictions and/or modifications be enforced in connection with synthesizing the genetic material 100, and the control module 112 may issue control instructions to the genetic material synthesis system 200 that include such restrictions and/or modifications.

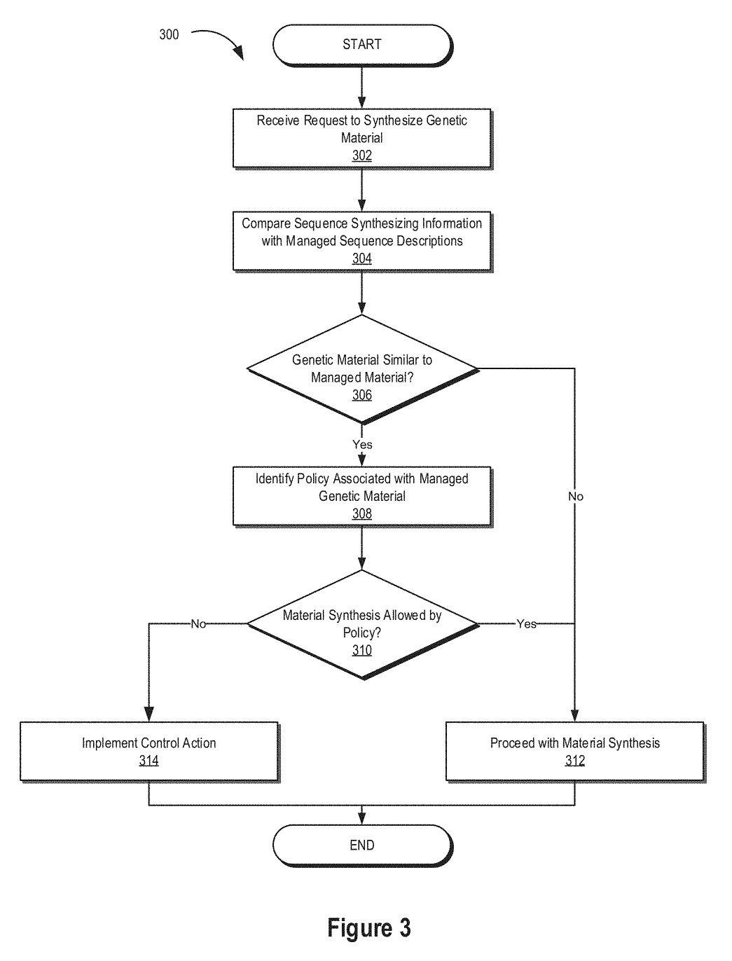

FIG. 3 illustrates a flow chart of a method 300 for managing synthesis of genetic material consistent with embodiments of the present disclosure. The illustrated method 300 may be implemented in a variety of ways, including using software, firmware, hardware, and/or any combination thereof. In certain embodiments, the method 300 may be implemented, at least in part, by a control module, a comparison module, and/or a policy module executing on a control system and/or a genetic material synthesis system as described above.

At 302, a request to synthesize a genetic material using a genetic material synthesis system may be received. In certain embodiments, the request may comprise sequence synthesis information. The sequence synthesis information may comprise any suitable information regarding a genetic material to be synthesized including, without limitation, one or more of genetic sequence information, certain steps and/or processes to be used by the genetic material synthesis system in connection with synthesizing the genetic material, and/or information relating to a molecular shape and/or structure of a genetic material.

A comparison may be performed at 304 based on the sequence synthesis information associated with the request to synthesize the genetic material received at 302 and information associated with one or more managed genetic materials. In certain embodiments, the comparison may include comparing and/or otherwise analyzing the material's genetic sequence and/or portions thereof, associated material synthesis process step information, and/or associated molecular shapes and/or structure reflected in the sequence synthesis information relative to information associated with one or more managed genetic materials.

Based on the comparison at 304, a determination may be made at 306 regarding whether the requested genetic material is the same or similar to one or more managed genetic materials. If the determination performed at 306 indicates the requested genetic material is not the same or similar to a managed genetic material, rendering of the genetic material by the genetic material synthesis system may proceed at 312. If, however, it is determined at 306 that the requested genetic material is the same or sufficiently similar to a known managed genetic material, one or more articulated policies associated with the known managed genetic material may be identified and/or enforced at 308.

At 310, a determination may be made regarding whether synthesis of the requested genetic material is allowed by the policy identified at 308. In certain embodiments, this determination may comprise determining whether one or more conditions for synthesizing the requested genetic material have been satisfied (e.g., demonstrating possession of a license or the like). If the determination at 310 indicates that synthesis of the requested genetic material is allowed by the policy identified at 308, synthesis of the genetic material by the genetic material synthesis system may proceed at 312. If, however, the determination at 310 indicates that rendering of the requested genetic material is not allowed by the policy identified at 308, a control action may be issued at 314 (e.g., an action preventing synthesizing of the genetic material by the genetic material synthesis system). In this manner, policy associated with known managed genetic materials may be enforced in connection with attempts to render a same and/or similar genetic material by a genetic material synthesis system.

In certain embodiments, various aspects of the disclosed genetic material analysis and/or comparison methods may be iterative in nature. For example, the comparison methods may utilize progressively more detailed and/or higher granularity comparisons (e.g., increasing sequence length comparisons) until it can be determined with desirable confidence than a genetic material and a managed genetic material are the same and/or or similar or are not the same and/or similar to a particular degree. In certain embodiments, by utilizing iterative comparison methods at varying degrees of granularity, processing power and/or time required to perform such comparisons may be more efficiently utilized.

In further embodiments, a variety of comparison techniques may be employed in connection with the disclosed embodiments. For example, a comparison of molecular shape and/or structure may be performed prior to analyzing specific sequence information, as the shape and/or structure of a genetic material may provide an indication of its bioactivity independent of a specific genetic sequence. Similarly, prior to performing a comparison of genetic sequence information, various embodiments may initially perform a hash comparison of a genetic sequence and/or portions thereof. If yet further embodiments, a comparison of control instruction and/or process step information may be performed prior to a comparison of genetic sequence information. It will be appreciated that a variety of other suitable comparison techniques and/or combination of techniques may be utilized in any suitable order to compare a genetic material with known genetic material in connection with the disclosed embodiments.

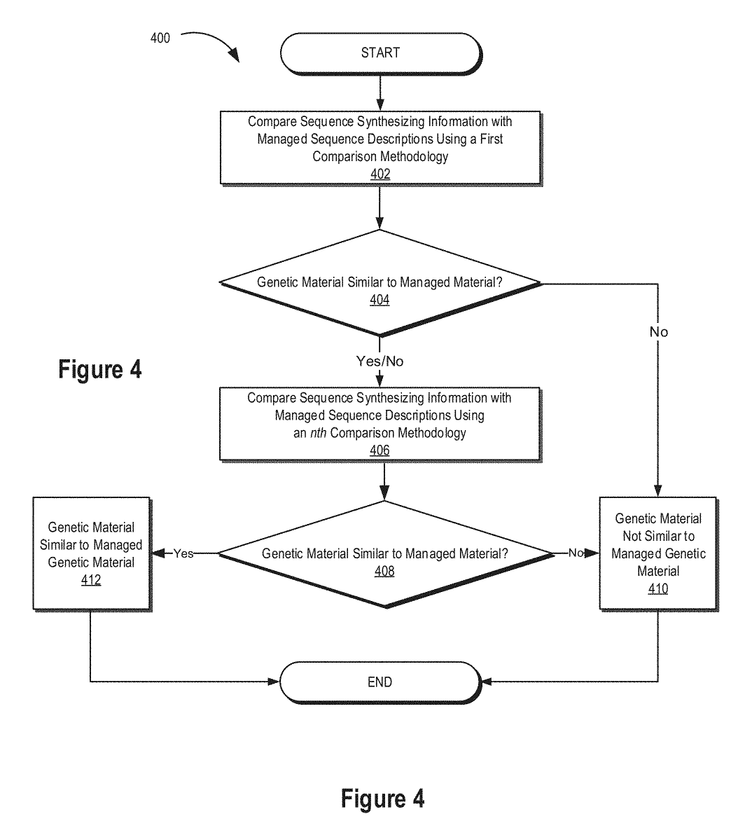

FIG. 4 illustrates a flow chart of an exemplary method 400 for comparing a genetic material with known managed genetic materials consistent with embodiments of the present disclosure. As detailed above, a plurality of techniques for comparing sequence synthesis information associated with a genetic material with managed sequence descriptions may be used in connection with various disclosed embodiments. For example, at 402, sequence synthesis information associated with a genetic material a user would like to synthesize may be compared with managed sequence description information associated with one or more managed genetic materials using a first comparison methodology. The first comparison methodology may comprise one or more of a sequence comparison, a hash comparison, comparison of synthesizing process steps, comparison of molecular shape and/or structure, and/or any of the comparison methodologies described herein.

At 404, a determination may be made based on the comparison at 402 whether the requested genetic material is similar to a known managed genetic material based on the first comparison methodology (e.g., similar to a particular degree and/or within a particular degree of confidence). If it is determined at 404 that the genetic materials are not similar based on the first comparison methodology, an indication that the genetic materials are not similar based on the first comparison methodology may be generated at 410 and communicated to a control module associated with a genetic material synthesis system.

In certain embodiments, if it is determined at 404 that the genetic materials are similar using the first comparison methodology, the method may proceed to 406. In further embodiments, regardless of whether it is determined at 404 that the genetic materials are similar using the first comparison methodology, the method may proceed to 406. For example, the first comparison methodology may compare genetic sequence information, but comparison of a molecular shape and/or structure of a genetic material to determine its bioactivity may be relevant regardless of whether the genetic sequences are similar.

At 406, sequence synthesis information associated with the genetic material may be compared with managed sequence description information associated with one or more managed genetic materials using an nth comparison methodology. The nth comparison methodology may comprise one or more of a sequence comparison, a hash comparison, comparison of synthesizing process steps, comparison of molecular shape and/or structure, and/or any of the comparison methodologies described herein, and may be different than the first comparison methodology. At 408, a determination may be made based on the comparison at 406 whether the requested genetic material is similar to a known managed genetic material based on the nth comparison methodology (e.g., similar to a particular degree and/or within a particular degree of confidence). If it is determined at 408 that the genetic materials are not similar based on the nth comparison methodology, an indication that the genetic materials are not similar based on the nth comparison methodology may be generated at 410 and communicated to a control module associated with a genetic material synthesis system. Otherwise, if it is determined at 408 that the genetic materials are similar based on the nth comparison methodology, an indication that the genetic materials are similar based on the nth comparison methodology may be generated at 412 and communicated to a control module associated with a genetic material synthesis system.

System and Device Architecture

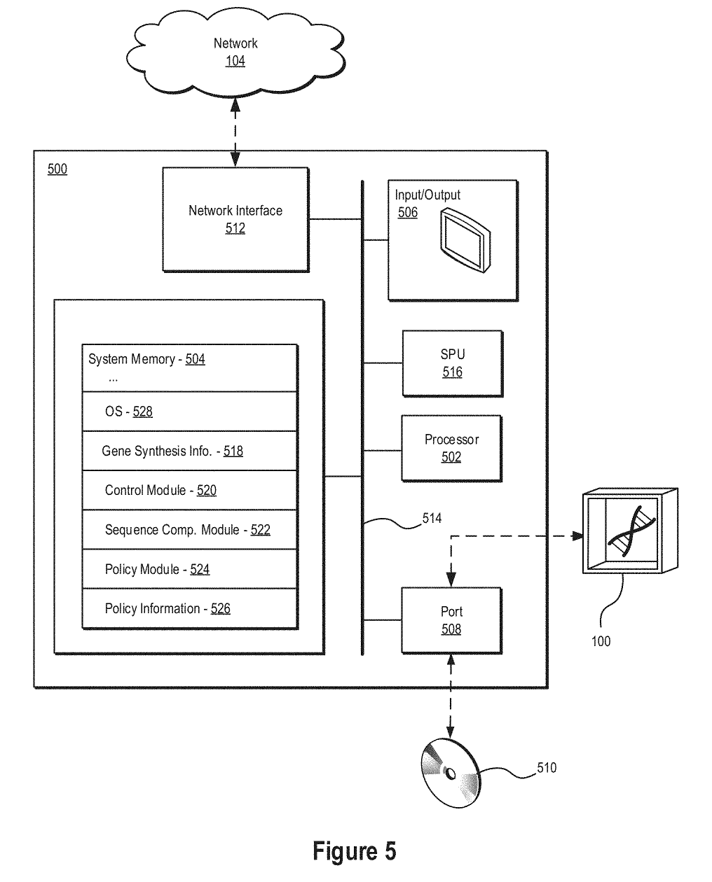

FIG. 5 illustrates a system 500 that may be used to implement certain embodiments of the systems and methods of the present disclosure. The system 500 may comprise a laptop computer system, a desktop computer system, a server computer system, and/or any other system or device configured to implement the systems and methods described herein. In certain embodiments, the system 500 may perform certain functions associated with a control system, a trusted authority, a genetic material synthesis system 100, any/or any other system disclosed herein.

As illustrated in FIG. 5, the system 500 may include: a processor 502; system memory 504, which may include high speed RAM, non-volatile memory and/or one or more bulk non-volatile computer-readable storage mediums (e.g., a hard disk, flash memory, etc.) for storing programs and other data for use and execution by the processor 502; an interface 506 (e.g., an input/output interface) that may include a display and/or one or more input devices such as, for example, a touchscreen, a keyboard, a mouse, a track pad, and the like; a port for interfacing 508 with removable memory 510 that may include one more diskettes, optical storage mediums, and/or other computer-readable storage mediums (e.g., flash memory, thumb drives, USB dongles, compact discs, DVDs, etc.) and/or a genetic material synthesis system 100; a network interface 512 for communicating with other systems via a network 104 using one or more communication technologies; and one or more buses 514 for communicatively coupling the aforementioned elements.

In certain embodiments, the network 104 may comprise the Internet, a local area network, a virtual private network, and/or any other communication network utilizing one or more electronic communication technologies and/or standards (e.g., Ethernet or the like). In some embodiments, the network interface 512 and/or network 104 may be part of a wireless carrier system, such as a PCS, and/or any other suitable communication system incorporating any suitable communication standards and/or protocols. In further embodiments, the network interface and/or network 104 may be part of an analog mobile communications network and/or a digital mobile communications network utilizing, for example, CDMA, GSM, FDMA, and/or TDMA standards. In still further embodiments, the network interface and/or network 104 may incorporate one or more satellite communication links and/or utilize IEEE's 802.11 standards, near-field communication, Bluetooth®, UWB, Zigbee®, and or any other suitable standard or standards.

In some embodiments, the system 500 may, alternatively or in addition, include a SPU 516 that is protected from tampering by a user of the system 500 or other entities by utilizing secure physical and/or virtual security techniques. An SPU 516 can help enhance and/or facilitate the security of sensitive operations such as private management and/or enforcement of policies and/or other aspects of the systems and methods disclosed herein. In certain embodiments, the SPU 516 may operate in a logically secure processing domain and be configured to protect and/or operate on secret information. In some embodiments, the SPU 516 may include internal memory storing executable instructions or programs configured to enable to the SPU 516 to perform secure operations.

The operation of the system 500 may be generally controlled by the processor 502 by executing software instructions and programs stored in the system memory 504 (and/or other computer-readable media, such as removable memory). The system memory 504 may store a variety of executable programs or modules for controlling the operation of the system. For example, the system memory 504 may include an operating system (“OS”) 528 that may manage and coordinate, at least in part, system hardware resources and provide for common services for execution of various functions. The system memory 504 may further include, without limitation, genetic material synthesis information 518, a control module 520 configured to provide control instructions to a coupled genetic material synthesis system 100, a comparison module 522 configured to perform various sequence comparison methods disclosed herein, a policy module 524 configured to enforce policy associated with managed genetic materials, and policy information 526 associated with managed genetic materials, and/or any other information, modules, and/or applications configured to implement embodiments of the systems and methods disclosed herein.

One of ordinary skill in the art will appreciate that the systems and methods described herein can be practiced with computing devices similar or identical to that illustrated in FIG. 5, or with virtually any other suitable computing device, including computing devices that do not possess some of the components shown in FIG. 5 and/or computing devices that possess other components that are not shown. Thus, it should be appreciated that FIG. 5 is provided for purposes of illustration and not limitation.

The systems and methods disclosed herein are not inherently related to any particular computer, electronic control unit, or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network. Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, a magnetic tape, a magnetic disk, flash memory, integrated circuits, or any other non-transitory digital processing apparatus memory device.

Although the foregoing has been described in some detail for purposes of clarity, it will be apparent that certain changes and modifications may be made without departing from the principles thereof. It should be noted that there are many alternative ways of implementing both the systems and methods described herein. Accordingly, the present embodiments are to be considered as illustrative and not restrictive, and the invention is not to be limited to the details given herein, but may be modified within the scope and equivalents of the appended claims.

What is claimed is:

1. A method performed by a system for controlling a genetic material synthesis system comprising a processor and a non-transitory computer-readable storage medium storing instructions that, when executed, cause the system to perform the method, the method comprising:
receiving a request to synthesize a genetic material with the genetic material synthesis system;
comparing information associated with the genetic material with information associated with one or more managed genetic materials;
determining, based on the comparison, that the genetic material is at least similar to at least one managed genetic material of the one or more managed genetic materials;
identifying a policy associated with the at least one managed genetic materials; and
enforcing the identified policy in connection with synthesizing the genetic material with the genetic material synthesis system.

2. The method of claim 1, wherein the comparing is based on at least a portion of sequence information associated with the genetic material and at least a portion of sequence information associated with the one or more managed genetic materials.

3. The method of claim 2, wherein the comparing comprises:
computing a first hash of the at least a portion of the sequence information associated with the genetic material;
computing a second hash of the at least a portion of the sequence information associated with the one or more managed genetic materials; and
comparing the first hash and the second hash.

4. The method of claim 1, wherein the comparing is based on process step information associated with the genetic material and process step information associated with the one or more managed genetic materials.

5. The method of claim 1, wherein the comparing is based on control instructions for the genetic material synthesis system associated with the genetic material and control instructions for the genetic material synthesis system associated with the one or more managed genetic materials.

6. The method of claim 1, wherein the comparing is based on molecular shape information associated with the genetic material and molecular shape information associated with the one or more managed genetic materials.

7. The method of claim 1, wherein determining that the genetic material is similar to at least one managed genetic material of the one or more managed genetic materials further comprises:
determining, based on the comparison, that the genetic material is similar to the at least one managed genetic material of the one or more managed genetic materials by a particular degree of measure.

8. The method of claim 1, wherein the policy comprises one or more restrictions on synthesizing the genetic material with the genetic material synthesis system.

9. The method of claim 1, wherein the policy comprises one or more conditions to be satisfied before synthesizing the genetic material with the genetic material synthesis system.

10. The method of claim 9, wherein the one or more conditions comprise a condition that an entity holding rights to the at least one managed genetic material be notified of the request to synthesize the genetic material.

11. The method of claim 9, wherein the one or more conditions comprise a condition that a law enforcement agency be notified of the request to synthesize the genetic material.

12. The method of claim 9, wherein the one or more conditions comprise a condition that the user demonstrate possession of an indication of authority to synthesize the genetic material with the genetic material synthesis system.

13. The method of claim 9, wherein the one or more conditions comprise a condition that the user purchase rights to synthesize the genetic material with the genetic material synthesis system.

14. The method of claim 9, wherein the one or more conditions comprise a condition that a stakeholder entity associated with the at least one managed genetic material be notified of the request to synthesize the genetic material.

15. The method of claim 1, wherein the policy comprises a requirement that the genetic material be modified in connection with synthesizing the genetic material with the genetic material synthesis system

16. The method of claim 15, wherein the modification is configured to render the genetic material bioactively innocuous.
